(19) United States
(12) Patent Application Publication
(10) Pub. No.: US 2007/0194579 A1
(43) Pub. Date: Aug. 23, 2007

(54) Adjustable locking mechanism for sliding closures

(76) Inventors: Scott Fiedler, Rancho Cucamonga, CA (US); Leslie William Burns, Mentone, CA (US)

Correspondence Address: Frank Frisenda, Suite D, 4386 S. Eastern Avenue, Las Vegas, NV, 89119, US

(21) Appl. No.: 11/346,930

(22) Filed: Feb. 4, 2006

(51) Int. Cl. E05C 19/18

(52) U.S. Cl. 292/293

(57) ABSTRACT

An adjustable locking mechanism is provided for sliding closures to limit sliding translation of a sliding window or patio door in a track of a channel. The locking mechanism includes a vise component having a fixed jaw member and an opposing moving jaw member spaced apart in an adjustable fixed relationship; and an eccentric cam component being rotatable between a first opened position and a second closed position. The cam component is contiguous with the vise component to exert sufficient retaining force, in the closed position, to mount the locking mechanism across the span of the channel to limit the sliding translation of the window or patio door in the track. Alternatively, the vise component is retained across the channel span by compression exerted by a integral threaded bolt and nut. Accordingly, the improved locking mechanism provides a convenient means for adjustably securing sliding windows or patio doors in channels of varying dimensions.

### BACKGROUND OF THE INVENTION

The present invention provides an adjustable locking mechanism for sliding closures such as a sliding window or a sliding patio door. In more detail, the inventive lock structure is particularly useful as a secondary lock mechanism, wherein the closure has primary locking mechanism and it is desired to provide for establishing one or more fixed positions for the sliding closure.

No other single component of a house affects comfort and energy consumption as much as windows and the like. Per square foot, windows, typically lose more heat in winter and gain more heat in summer than the walls or roof of a house. Windows also admit useful solar heat in winter.

Generally, three characteristics determine a window's energy efficiency. The first is R-value which controls heat loss in winter and, to a lesser degree, heat gain in summer. The second is air leakage, which can cause significant energy waste year-round. The third is solar transmission, which controls unwanted solar heat gain in summer as well as useful “passive solar heating” during winter. The homeowners' quest to improve such characteristics, and to improve the homes' aesthetics has fueled the demand for energy-efficient new windows.

Window and sliding door frames are typically constructed of wood, vinyl, or aluminum. From an energy standpoint, vinyl frames are the best, especially if insulated with foam or fiber insulation.

Most vinyl replacement window designs use multi-chambered hollow extruded vinyl frame and window sash sections, with thicker frame rails.

Various types of secondary locking mechanisms for use with sliding closures are known in the art. Some of these structures are pivoted stop devises usable with doors or windows for holding the closure in either a fully or partially-open position.

Miller, et al. in U.S. Pat No. 6,457,752 B1 issued Oct. 1, 2002, discloses a locking window. The window includes a window frame including a window sash which is selectively movable between a first closed position and a second open position. A window latch is adapted to be attached to the window and is selectively movable between a first open position and a second locked position to secure the window sash in the closed position. The window latch includes a sweep latch, which is preferably offset, and a non-compressible pivot fastener for attaching the window latch to the window. The offset arrangement provides sufficient space for substantially unequal length actuator and locking arms to provide a mechanical advantage when the window latch is operated. The pivot fastener includes a support brushing and a fastener offset sweep latch to the window.

Royer in U.S. Pat No. 3,640,559 issued Feb. 8, 1972, for “Security Devise for Sliding Windows and Doors” discloses an elongated arcuate bar provided along its bottom edge with at least one pair of transverse, spaced, parallel slots aligned on a chord of a segment of the arc to fit over one of the vertical walls of a track carrying a sliding window or door. A portion of the bar spanning the slots projects into the track into interfering relation with the adjacent corner of the window or door and prevents further movement in the direction of the stop. Clip members on top of the window or door preclude lifting movement of the window or door and removal thereof from the track.

Hawkins in U.S. Pat. 4,190,271, issued Feb. 26, 1980, discloses a lock for use in conjunction with a window panel slidably supported in a track of a channel member. The Hawkins'devise includes a stop member which is permanently and translatable secured in the track of the channel member. The stop member impinges on selected ones of the weep hole openings in the channel member to limit the sliding translation of the window panel in its track.

While these devises work well for older wooden-frame and aluminum-frame windows and sliding patio doors, ventilating locks or other items require drilling holes in the closure frame to mount the locking mechanism. However, drilling holes in the frame of a vinyl window or other similar frame structure can damage the entire structural integrity of the window.

Accordingly, those skilled in the art have recognized a significant need for an improved locking mechanism for sliding closures that does not require drilling holes for mounting the locking mechanism. Further, the improved locking mechanism provides a convenient means for adjustably securing the locking mechanism between a first closed position and second opened position to limit the sliding translation of the closure panel in its track. The present invention fulfills these needs.

### SUMMARY OF THE INVENTION

An adjustable locking mechanism is provided for sliding closures to limit sliding translation of a sliding window or patio door in a track of a channel. The locking mechanism includes a vise component having a fixed jaw member and an opposing moving jaw member spaced apart in an adjustable fixed relationship; and an eccentric cam component being rotatable between a first opened position and a second closed position. The cam component is contiguous with the vise component to exert sufficient retaining force, in the closed position, to mount the locking mechanism across the span of the channel to limit the sliding translation of the window or patio door in the track.

In a second embodied form, the vise component comprises an integral threaded bolt and nut which when tightened exerts compressive force on the opposing jaw members. When suitably mounted, the threaded bolt and nut of the vise component is tightened to exert sufficient retaining force across the channel span to limit the sliding translation of the window or patio door in the track.

Accordingly, the improved locking mechanism provides a convenient means for adjustably securing sliding windows or patio doors in channels of varying dimensions.

The present invention provides and improved locking mechanism for sliding closures such as a sliding window or patio door, wherein the closure panel is slidably supported in a track of a channel member. The locking mechanism includes a stop member which is adjustably secured in the track of the channel member. The stop member comprises securement means to limit the sliding translation of the closure panel in its track.

A portion of the locking mechanism spans the sliding track and interferes with and fixes the adjacent edge of the closure framepost such as a window or a sliding door to prevent further movement in the track of the channel.

The cam component comprises a cam body and a cam lever that is selectively adjusted between a first closed position and a second opened position. In more detail, a rotatable eccentric cam body includes a T-bolt wherein the threaded portion of the bolt is received through each end wall of the opposing jaw members of the vise component.

In one embodied form, the vise component includes a fixed jaw member having a sliding baseplate, with the jaw exposed on a rear portion of the lock mechanism to be contacted with a first rail wall of a channel adjacent to an interior frame post of the closure. The movable jaw member protrudes downwardly from a sliding baseplate of the fixed jaw member and is reciprocatively held in the baseplate to be extendable but retained therein. A plurality of rack teeth are equally spaced and longitudinally formed on a upper end wall surface of the opposing jaw members to grip the upstanding wall surfaces of the of the channel forming the sliding track.

The lock mechanism, when suitably mounted across the channel span has a wall facing the side frame of the closure for retarding the movement of the closure along the channel track.

The adjustable locking mechanism may be conveniently sized to fit channel tracks of varying dimensions. In this respect, the jaw members of the vise component are spaced apart in a fixed relationship by means of the longitudinal bolt threaded through the upstanding end walls of each jaw member. If this spaced relationship is to be shortened, or lengthened, to mount the mechanism onto a particular channel span, the user will simply rotate the cam body to fix the spaced relationship of the jaw members to the desired width.

Accordingly, the improved locking mechanism provides a convenient means for adjustably securing sliding windows or patio doors in channels of varying dimensions.

### BRIEF DESCRIPTION OF THE DRAWINGS

FIG. 1 shows a top view of one embodied form of the adjustable locking mechanism for sliding closures in accordance with the present invention;

FIG. 2 is a bottom view of the inventive adjustable locking mechanism depicted in FIG. 1;

FIG. 3 is a side view of the adjustable locking mechanism shown in FIG. 1;

FIG. 4 is a side view of the adjustable lodging mechanism further depicting a jaw member in an opened position;

FIG. 5 is a perspective view of the adjustable locking mechanism affixed in a channel member to limit the sliding translation of a window frame panel thereon; and

FIG. 6 is a perspective view of a second embodied form of the adjustable locking mechanism illustrating the vise component with integral threaded bolt and nut,

### DETAILED DESCRIPTION OF THE PREFERRED EMBODIMENTS

An adjustable locking mechanism for sliding closures to limit the sliding translation of a closure panel in a track of a channel member having a pair of upstanding sidewalls defining a channel span, the locking mechanism comprising: a vise component comprising a fixed jaw member and an opposing moving jaw member, the jaw members being spaced apart in an adjustable fixed relationship for mounting and for retaining the locking mechanism across the channel span; an eccentric cam component comprising a cam body and cam lever, said cam component being rotatable between a first opened position and a second closed position; said cam component being contiguously disposed with respect to said vise component to exert sufficient retaining force on said vise component in the closed position, to mount said locking mechanism across said channel span to limit the sliding translation of the closure panel in the track.

The fixed relationship between said jaw members of said vise component may be adjustably maintained by a positioning screw threaded through the respective end walls of the opposing jaw members.

In a second embodied form, the vise component comprises an integral threaded bolt and nut which when tightened exerts compressive force on the opposing jaw members. When suitably mounted, the threaded bolt and nut of the vise component is tightened to exert sufficient retaining force across the channel span to limit the sliding translation of the window or patio door in the track.

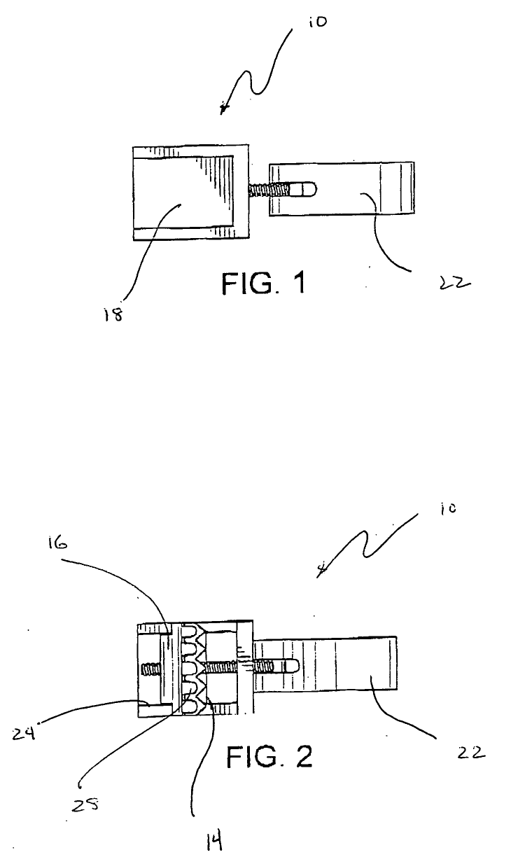

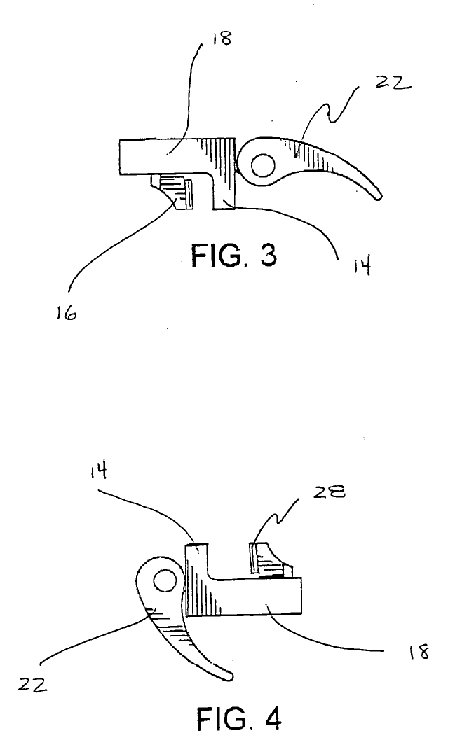

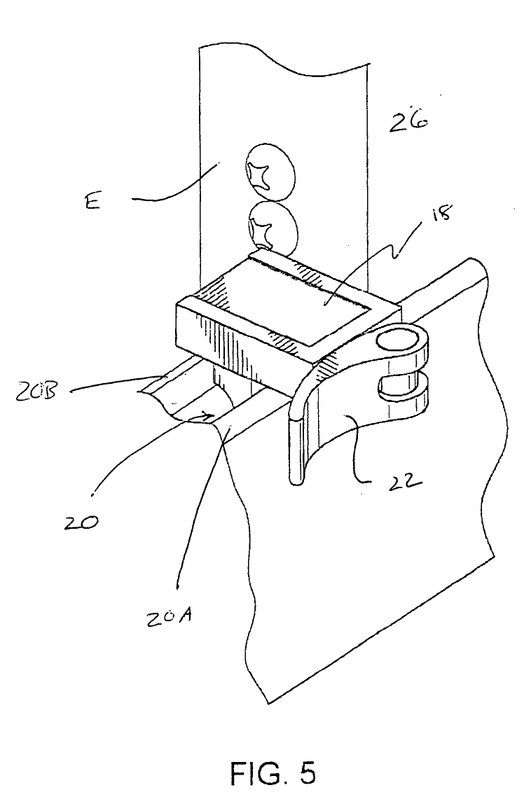

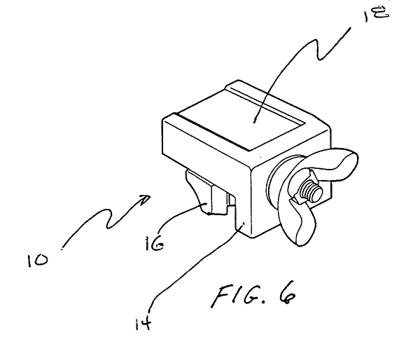

Referring now to FIG. 1 there is shown a top view of one embodied form of the adjustable locking mechanism 10 for sliding closures in accordance with the present invention.

As seen most clearly in FIG. 2, the mechanism 10 comprises a vise component 12 having two jaw members 14 and 16 telescopically mounted in a bottom of the lock body 18 to be firmly tensioned or retained on the rail 20 as driven by a rotatable cam latch 22 for retarding a sliding opening of the window and door.

The lock body 18 includes a sliding slot 24 longitudinally disposed in the bottom portion of the lock body 18.

The vise component 12 includes: a fixed jaw member 14 disposed on a rear wall of the lock body 18 to be contacted with a first rail wall 20A of a window and door rail means 20 adjacent to an exterior E of the window and door 26, a movable jaw member 16 protruding downwardly from a sliding plate 24 slidably reciprocatively held in the lock body 18 to be extendibly retained on a second rail wall 20B of the rail means 20 adjacent to the fixed jaw member 14. A plurality of rack teeth 28 are equally spaced and longitudinally formed on an upper surface of each jaw member 14 and 16, with each rack tooth 28 generally arcuate shaped. Each jaw member 14 Ind 16 may be coated with an elastomeric or rubber coating on its inner or outer surface for enhancing its friction with the rail means 20.

Accordingly, the present invention provides an adjustable locking mechanism for sliding closures to limit the sliding translation of a closure panel in a track of a channel member having a pair of upstanding sidewalls defining a channel span, the locking mechanism comprising: a) a vise component comprising a fixed jaw member and an opposing moving jaw member, the jaw members being spaced apart in an adjustable fixed relationship for mounting and for retaining the locking mechanism across the channel span; and b) means for exerting compressive force on said fixed jaw member and said opposing moving jaw member of said vice component in the closed position to mount said locking mechanism across said channel span to limit the sliding translation of the closure panel in the track.

1. An adjustable locking mechanism for sliding closures to limit the sliding translation of a closure panel in a track of a channel member having a pair of upstanding sidewalls defining a channel span, the locking mechanism comprising:
a) a vise component comprising a fixed jaw member and an opposing moving jaw member, the jaw members being spaced apart in an adjustable fixed relationship for mounting and for retaining the locking mechanism across the channel span; and
b) means for exerting compressive force on said fixed jaw member and said opposing moving jaw member of said vice component in the closed position to mount said locking mechanism across said channel span to limit the sliding translation of the closure panel in the track.

2. The adjustable locking mechanism as defined in claim 1, wherein the means to exert compressive force on said fixed jaw member and opposing moving jaw member is an eccentric cam component comprising a cam body and cam lever, said cam component being rotatable between a first opened position and a second closed position; said cam component being contiguously disposed with respect to said vise component to exert sufficient retaining force on said vise component in the closed position, to mount said locking mechanism across said channel span to limit the sliding translation of the closure panel in the track.

3. The adjustable locking mechanism as defined in laim 1, wherein the adjustable fixed relationship between said jaw members of said vise component is maintained by a positioning screw.

4. The adjustable locking mechanism as defined in laim 1, wherein said vise component comprises an integral threaded bolt and nut which when tightened exerts compressive force on the opposing jaw members.

5. The adjustable locking mechanism as defined in laim 1, wherein the adjustable fixed relationship between said jaw members of said vise component is maintained by a positioning wing nut.
